(19) United States
(12) Patent Application Publication
(10) Pub. No.: US 2007/0125567 A1
(43) Pub. Date: Jun. 7, 2007

(54) Six sides box

(76) Inventor: Bruno Coissac, Asnieres / Seine (FR)

Correspondence Address: Bruno Coissac, 258 Avenue D'Argenteuil, Asnieres Sur Seine, 92600, FR

(21) Appl. No.: 10/519,568

(22) PCT Filed: Jul. 3, 2003
(86) PCT No.: PCT/FR03/02065

§ 371 Date: Feb. 17, 2006

(30) Foreign Application Priority Data
Aug. 2, 2002 (FR) 02/09851

(51) Int. Cl. H02G 3/08

(52) U.S. Cl. 174/50

(57) ABSTRACT

The inventive six sides box which can be closed is characterized in that the sides thereof are produced by two assembled metal plates or sheets (T1, T2), each sheet having only one fold (P). Said box is used, in particular for small and middle sized electronic, electric and mechanical systems.

This invention concerns a box to house electrical, electronic and mechanical systems.

Many electrical, electronic and mechanical systems are housed in boxes necessitating more than two folding operations for their manufacture.

The box according to the invention comprises six faces. It is characterised by the fact that all of these faces are constituted by two plates or sheets each folded once only and assembled. The fold obtained on each plate or sheet forms a curve which constitutes one of the six faces, giving two curved faces and four faces which may be flat.

According to specific modes of production:

the two plates or sheets can be assembled by brackets and means of attachment, by gluing or by welding depending on the material used, or by slides fitted inside one of the two plates or sheets.

if a closed box with joined outer walls is required, one of the two plates or sheets may comprise two edges cut in a curved way so that these two edges are surrounded by the fold of the second plate or sheet when they are assembled.

the two plates or sheets may have holes made in them to accommodate surface or internal components depending on the required applications.

The appended drawings illustrate the invention according to a mode of production:

FIG. 1 shows in a perspective view one of the two plates or sheets comprising two edges cut in a curved way.

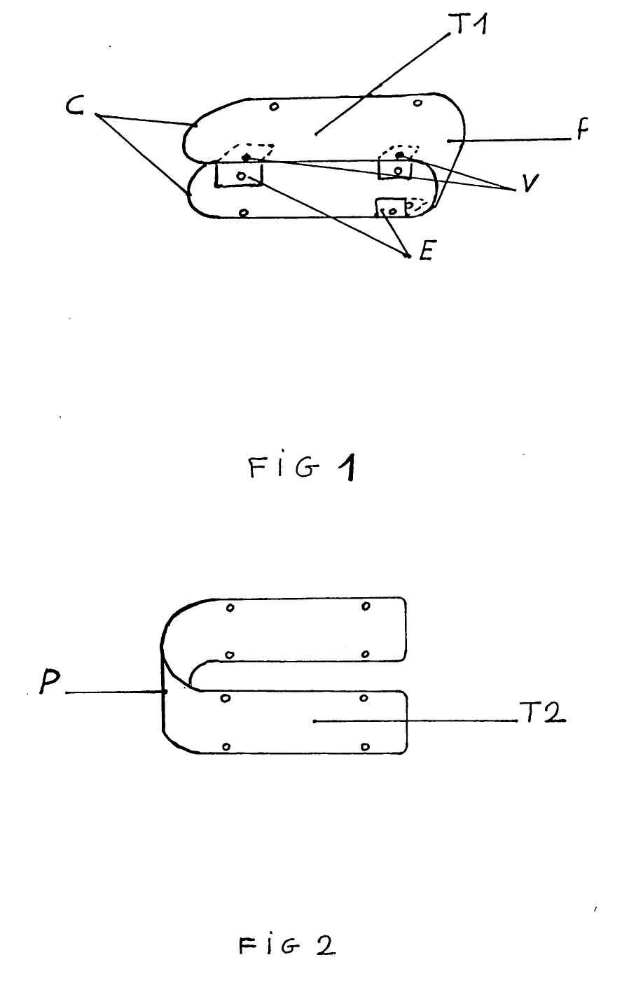

FIG. 2 shows in a perspective view the second plate or sheet.

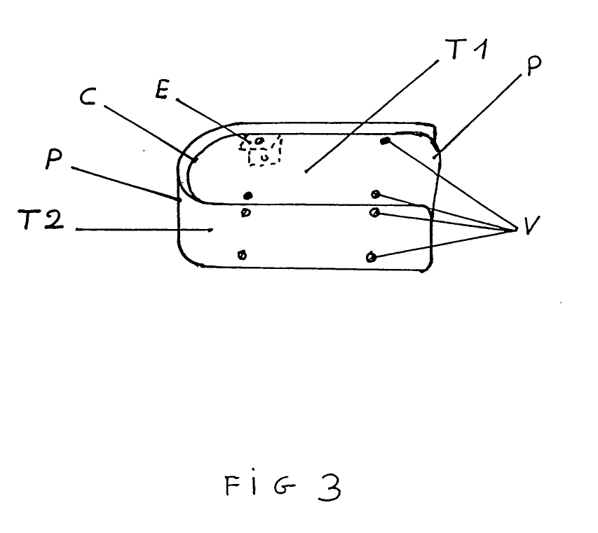

FIG. 3 shows in a perspective view the box formed by the assembly of the two plates or sheets.

In reference to these drawings the two plates or sheets (T1, T2) may be in aluminium two mm thick and assembled by threaded brackets (E) and screws (V).

One of two plates or sheets (T1) comprises, before being folded, two edges cut in a straight way and two edges cut in a curved way (C) in a semi-circle. This plate or sheet (T1) has holes made in eight places to accommodate eight screws (V) which will hold eight threaded brackets (E).

This plate or sheet (T1) is then folded at its centre. The fold (P) obtained forms an arc of a circle.

The second plate or sheet (T2) comprises, before being folded, two edges cut in a straight way.

This plate or sheet (T2) then has holes made in it in eight places to accommodate eight screws (V) which will hold the eight threaded brackets (E).

This plate or sheet (T2) is then folded at its centre. The fold (P) obtained forms an arc of a circle of sufficient dimensions to surround the two edges cut in a curved way (C) on the other plate or sheet (T1) when the two plates or sheets (T1, T2) are assembled and held together by the eight threaded brackets (E) and the sixteen screws (V).

A fitting made of flexible material may be provided to surround the edge of the second plate or sheet (T2).

This box is particularly designed to accommodate small and medium-sized electronic, electrical and mechanical systems.

1) Box with six faces characterised by the fact that all of its faces are constituted by two plates or sheets (T1, T2) each folded once and assembled. The fold (P) obtained on each plate or sheet (T1, T2) forms a curve which constitutes one of the six faces.

2) Box with six faces in accordance with claim 1 characterised by the fact that one of the two plates or sheets (T1) comprises two edges cut in a curved way (C).

3) Box with six faces in accordance with claim 2 characterised by the fact that the two edges cut in a curved way (C) of one of the two plates or sheets (T1) are surrounded by the fold (P) of the second plate or sheet (T2) when the two plates or sheets (T1, T2) are assembled.
